(19) United States
(12) Patent Application Publication
(10) Pub. No.: US 2022/0055076 A1
(43) Pub. Date: Feb. 24, 2022

(54) CLEANING APPARATUS AND METHOD FOR CLEANING COMPONENTS

(71) Applicant: ECOCLEAN GMBH, Filderstadt (DE)

(72) Inventor: Alexander Genze, Simmerath (DE)

(21) Appl. No.: 17/519,689

(22) Filed: Nov. 5, 2021

Related U.S. Application Data
(63) Continuation of application No. PCT/EP2020/062742, filed on May 7, 2020.

(30) Foreign Application Priority Data
May 8, 2019 (DE) 102019112046.2
Jun. 14, 2019 (DE) 102019116307.2

(51) Int. Cl. B08B 5/02; B08B 13/00; B08B 7/02; B08B 7/04; H02K 15/00

(52) U.S. Cl. CPC B08B 5/023; B08B 13/00; H02K 15/00; B08B 7/04; B08B 7/02

(57) ABSTRACT

The invention relates to a cleaning apparatus for cleaning, in particular, electrical components with a gaseous cleaning medium, comprising a receiving device to which the component is fixed or fixable, a nozzle device with at least one nozzle element directed or directable at the component, and a holding device for said nozzle element, wherein at least one nozzle element is adapted to at least one contour of the component, in particular an outer contour or an envelope surface, as well as a pressurization device for acting upon the nozzle device with the cleaning medium, wherein at least one nozzle element of the nozzle device is exchangeably and, in particular, releasably fixable or fixed to the holding device, and wherein the cleaning apparatus comprises at least one drive device, which is in operative connection with the component and/or with the nozzle device, for achieving a relative movement of the component and the at least one nozzle element during the cleaning. The invention also relates to a method.

### CROSS-REFERENCE TO RELATED APPLICATIONS

This application is a continuation application of international application number PCT/EP2020/062742, filed on May 7, 2020, and claims the benefit of German patent applications number 10 2019 112 046.2, filed on May 8, 2019, and 10 2019 116 307.2, filed on Jun. 14, 2019, which are incorporated herein by reference in their entirety and for all purposes.

### FIELD OF THE INVENTION

The present invention relates to a cleaning apparatus and a method for cleaning, in particular, electrical components with a gaseous cleaning medium The present invention also relates to a method for cleaning, in particular, electrical components with a gaseous cleaning medium.

### BACKGROUND OF THE INVENTION

Electrical components, for example for electrical circuits or electric motors, may have sensitive assemblies, for example assemblies comprising circuit boards or coils that have to be cleaned in a targeted manner during and/or after production. For example, particulate contamination that can lead to electrical short circuits and breakdowns in the operation of the components and is responsible for the failure of electrical components must be removed. A dry cleaning by means of a gaseous (gas or gas mixture) cleaning medium is desirable, a targeted cleaning of the components being advantageous. It is known to blow off electrical components by means of compressed air and to remove particles from same.

The presently described cleaning apparatus and the described method can be used with components of various kinds, but are particularly suited for electrical components. For example, they may be components for electric motors like coil bodies, housings, bearings, or shafts, particularly components with a rotational symmetry or with a cylindrical configuration at least in sections, alternatively components for power electronics or electrical circuit boards.

An object underlying the present invention is to provide a cleaning apparatus and a method for cleaning, in particular, electrical components, which has an improved cleaning performance.

### SUMMARY OF THE INVENTION

In a first aspect of the invention a cleaning apparatus for cleaning, in particular, electrical components with a gaseous cleaning medium comprises a receiving device to which the component is fixed or fixable, a nozzle device with at least one nozzle element directed or directable at the component and a holding device for said nozzle element, wherein at least one nozzle element is adapted to at least one contour of the component, in particular an outer contour or an envelope surface. The cleaning apparatus further comprises a pressurization device for acting upon the nozzle device with the cleaning medium, wherein at least one nozzle element of the nozzle device is exchangeably and, in particular, releasably fixable or fixed to the holding device. The cleaning apparatus comprises at least one drive device, which is in operative connection with the component and/or with the nozzle device, for achieving a relative movement of the component and the at least one nozzle element during the cleaning.

In a second aspect of the invention, a method for cleaning, in particular, electrical components with a gaseous cleaning medium is provided, in which at least one nozzle element of a nozzle device adapted to at least one contour of the component, in particular an outer contour or an envelope surface, is selected in dependence on the component and is directed at the component and the component is acted upon with the cleaning medium. The component and the at least one nozzle element are moved relative to one another during the cleaning. The selection of the nozzle element comprises, in particular, the exchange of the at least one nozzle element on a holding device.

### BRIEF DESCRIPTION OF THE DRAWINGS

The foregoing summary and the following description may be better understood in connection with the drawing figures, of which:

FIG. 1: shows a perspective depiction of a cleaning apparatus in accordance with the invention;

FIG. 2: shows a schematic partial depiction of a further cleaning apparatus in accordance with the invention;

FIG. 3: shows a simplified cut view along the line 3-3 in FIG. 2;

FIG. 4: shows a schematic partial depiction of a further cleaning apparatus in accordance with the invention; and

FIG. 5: shows a detailed depiction of a nozzle element of the cleaning apparatus from FIG. 4.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details with the scope and range of equivalents of the claims and without departing from the invention.

The present invention relates to a cleaning apparatus for cleaning, in particular, electrical components with a gaseous cleaning medium. The cleaning apparatus comprises a receiving device to which the component is fixed or fixable, a nozzle device with at least one nozzle element directed or directable at the component and a holding device for said nozzle element, wherein at least one nozzle element is adapted to at least one contour of the component, in particular an outer contour or an envelope surface. The cleaning apparatus further comprises a pressurization device for acting upon the nozzle device with the cleaning medium, wherein at least one nozzle element of the nozzle device is exchangeably and, in particular, releasably fixable or fixed to the holding device. The cleaning apparatus comprises at least one drive device, which is in operative connection with the component and/or with the nozzle device, for achieving a relative movement of the component and the at least one nozzle element during the cleaning.

The cleaning apparatus in accordance with the invention has a high versatility by being able to be adapted in a simple manner to components to be cleaned, due to the possibility of exchanging at least one nozzle element of the nozzle device. For this purpose, at least one nozzle element can be exchanged, for example by it being releasably fixed to the holding device. In a preferred embodiment, a preferably controllable adjusting device for exchanging at least one nozzle element may be provided. By means of the adaptation of the nozzle element to components to be cleaned, said components can be cleaned in a targeted manner. Here, in particular, the nozzle element is adapted to a contour of the component. Said contour may be, for example, an outer contour, for example the contour of an outer surface or the contour of end faces of the component. Alternatively or in addition, the adaptation of the nozzle element to an inner contour of the component may be provided, for example the contour of cavities into which the nozzle element can be inserted. The better cleaning result compared to a conventional cleaning apparatus that is achieved by this configuration can be further improved by, in accordance with the invention, a drive device being provided, with which the at least one nozzle element and the component are moved relative to one another during the cleaning and different surface portions of the component can be covered.

The present object is achieved by a method in accordance with the invention for cleaning, in particular, electrical components with a gaseous cleaning medium, in which method at least one nozzle element of a nozzle device adapted to at least one contour of the component, in particular an outer contour or an envelope surface, is selected in dependence on the component and is directed at the component and the component is acted upon with the cleaning medium. The component and the at least one nozzle element are moved relative to one another during the cleaning. The selection of the nozzle element comprises, in particular, the exchange of the at least one nozzle element on a holding device.

The advantages that have been mentioned in the context of the explanation of the cleaning apparatus can also be achieved using the method, such that reference can be made to the preceding statements in this regard.

Advantageous embodiments of the method in accordance with the invention result from advantageous embodiments of the cleaning apparatus in accordance with the invention. These embodiments described in the following can be implemented in accordance with the method, such that only these embodiments of the cleaning apparatus will be discussed to avoid repetition.

The at least one drive device is advantageously configured to achieve a relative rotation of the component and the at least one nozzle element and/or to achieve a translational movement of the component and the at least one nozzle element relative to one another.

A frequency of the rotation of the component and/or the nozzle element or a rotation frequency of the relative rotation may be, e.g., about 0.1 revolutions per second to 50 revolutions per second, preferably up to about 10 revolutions per second.

In the case of a translational movement, in particular linear, rectilinear movement, a speed of the relative movement of the component and the at least one nozzle element may be, e.g., about 1 mm per second to 100 mm per second.

The gaseous cleaning medium may be, in particular, pressurized air.

The relative overpressure of the cleaning medium may be, e.g., from above 0 bar to about 15 bar, preferably about 0.2 bar to 5 bar.

The pressurization device may comprise, in particular, a pump assembly.

The temperature of the cleaning medium may preferably be above about 0° C. to about 80° C., preferably about 15° C. to 60° C.

The relative humidity of the cleaning medium is preferably less than about 60%.

The cleaning apparatus may preferably comprise a conditioning device for setting the temperature and/or the humidity of the cleaning medium, in particular in dependence on the cleaning task to be performed and/or on the workpiece.

The intensity of the cleaning may preferably be settable. The setting, in particular by controlling the cleaning apparatus by means of a control device thereof, may comprise, for example, at least one of the following:
setting the pressure of the cleaning medium;
setting the process time of the action on the component by means of at least one nozzle element and preferably a plurality of nozzle elements;
setting a speed of the relative movement of the component and at least one nozzle element, rotationally and/or translationally;
setting or changing a direction of the relative rotation and/or a movement direction of the component and at least one nozzle element, for example providing a repeated reversal of the direction of rotation;
optionally selecting and setting the cleaning medium. Depending on the cleaning task to be performed, provision may be made that the cleaning medium is selectable;
setting the cross section of at least one nozzle opening of at least one nozzle element.

Provision may be made that the cleaning medium is suctionable. The relative underpressure may be, e.g., from about −10 mbar to −500 mbar.

Provision may be made that a filter element for cleaning the cleaning medium is present on the upstream side of the nozzle device. In this way, the fed cleaning medium can be freed from particles.

Provision may be made that the cleaning apparatus comprises or form a cleaning chamber. In the cleaning chamber, a preferably vortexed flow of cleaning medium can be provided upon being applied with overpressure and/or with underpressure. Particles adhering to the component can be detached and discharged by means of the vortexed flow. Provision may be made that the cleaning medium tangentially flows into the cleaning chamber, in relation to an axis defined by said cleaning chamber. This axis may, for example, coincide with an axis of rotation for the component or the nozzle device.

Provision may be made that the component can be acted upon by means of an electrical application device (DC and/or AC electrodes). The action may take place, for example, during the cleaning by means of the cleaning medium. Alternatively or in addition, an action during the exchange of the component, for example with the feed device referred to below, is conceivable.

Provision may be made that the at least one nozzle element is stationarily fixed to the holding device and that the component is rotated or displaced relative to the nozzle element by means of the drive device, or that the component is stationarily fixed to the receiving device and that the at least one nozzle element is rotated or displaced relative to the component by means of the drive device.

The at least one nozzle element may be fixed to the holding device, for example by force-locking and/or positive-locking connection. In particular, a screw connection, a latching connection, and/or a clamping connection is conceivable. It may be advantageous if the at least one nozzle element is manually and, in particular, toollessly fixable to the holding device in order to keep the required equipping or exchange times for the at least one nozzle element low.

Corresponding alignment elements or coding elements on the at least one nozzle element and the holding device are advantageous for ensuring a clear alignment.

It is advantageous if the cleaning apparatus comprises a preferably electrically controllable adjusting device, by means of which the at least one nozzle element is exchangeably held on the holding device. The cleaning apparatus proves to be particularly versatile in this way. Depending on the cleaning task to be performed, preferably in dependence on the component to be cleaned, at least one nozzle element can be exchanged by the adjusting device. For example, the previously mentioned control device can control the adjusting device. The adjusting device may be actuable by a user or automatically, for example in dependence on a component detected by means of a detection unit.

Overall, it is advantageous if the cleaning apparatus comprises a detection unit with which the component is detectable, wherein at least one cleaning operation and/or at least one cleaning parameter is settable in dependence on the component. The detection may preferably take place contactlessly, for example optically and/or by means of a different kind of electromagnetic radiation, for example by an RFID or NFC technology. Provision may be made that a marking on the component or a support element (for example the receiving device) for the component is hereby contactlessly detected.

The nozzle device advantageously comprises a set of nozzle elements that are mutually exchangeable and preferably exchangeable by means of an adjusting device. A sort of “inventory” may be provided from which the user can make a selection with a view to the cleaning task and the component. The selection by means of the adjusting device may advantageously take place automatically without intervention by the user.

In a preferred embodiment, the at least one nozzle element, in particular a nozzle opening of the at least one nozzle element, is adapted to rotationally symmetrically configured components or components that are of cylindrical configuration at least in sections. For example, at least one nozzle element is adapted to clean an outer surface of a component, wherein an outer surface of the component can be cleaned along the entire periphery while the component is being rotated. Alternatively or in addition, at least one nozzle element may be adapted to clean an end face of the component, said nozzle element being rotatable about an axis passing transversely and, in particular, perpendicularly through the end face.

It is understood that at least one nozzle element may comprise a plurality of openings with which different portions of the component can be cleaned depending on the orientation relative to the component. For example, it is possible to clean different sides of the component by means of only one nozzle element. For example, an outer surface and an end face of the component can be cleaned at the same time.

Overall, it is advantageous if the components can be acted upon axially and/or radially and/or tangentially with cleaning medium by means of the at least one nozzle element, in relation to an axis defined by the component, wherein the component axis may advantageously coincide with an axis of rotation for rotating the component. The action axially and/or radially and/or tangentially may take place by way of a plurality of nozzle openings of the nozzle element or, alternatively, by way of only one nozzle opening, with which the aforementioned surfaces of the component can be acted upon.

It is favorable if the cleaning apparatus comprises a vibration device for acting upon the component with vibrations. A vibrational frequency may be, e.g., about 1 Hz to 1000 Hz, preferably about 50 Hz to 200 Hz. As a result of the vibration, adhering particles can be detached and the cleaning result thereby improved. The vibrations may be harmonic or anharmonic, for example with a noise-like vibrational spectrum. The vibrations may be periodic or aperiodic and/or continuous or interrupted.

Provision may be made that the component itself is acted upon with vibrations. Alternatively or in addition, an indirect action may be provided, wherein the receiving device is set into vibration.

A decoupling of the vibration from the remaining components of the cleaning apparatus is favorable, for example by way of vibration dampers.

In a preferred embodiment, provision is made that at least one nozzle element of the nozzle device comprises a nozzle body with a supply portion and a dispensing portion having at least one nozzle opening, wherein the nozzle body is formed at least partially in one piece and a flow channel for the cleaning medium is integrally formed in the supply portion and/or in the dispensing portion. As a result of the one-piece production, in particular by means of generative manufacturing, a particularly good adaptation of the nozzle element to the component to be cleaned can be achieved in practice.

In particular, it may be advantageous if the nozzle body is produced at least in sections by means of a generative manufacturing process, in particular by means of 3D printing, specifically at the dispensing portion. By means of the generative manufacturing, for example 3D printing, advantageous structures of the nozzle body can be formed with a view to a particularly good cleaning result.

For example, a flow-optimized air guidance can be formed in the flow channel and/or at the nozzle opening. This can be achieved, for example, by no abrupt transitions with a non-constant tangent being present at flow-guiding portions of the nozzle body.

Transitions between flow-conducting portions for example with cross sectional and/or directional changes, advantageously have radii. The radii may preferably be in the range of about 1 mm to 5 mm.

Flow-guiding portions in the interior of the nozzle body have, e.g., diameters of about 0.5 mm to 3 mm. Conducting contours may be provided at flow-guiding portions for flow-optimized guidance of the cleaning medium.

Nozzle openings may have, e.g., lengths of about 1 mm to 1000 mm, preferably up to about 200 mm and/or widths of about 0.1 mm to 15 mm, preferably 0.5 mm to 5 mm.

At least one nozzle element may form a Laval nozzle; a generative manufacturing proves to be advantageous for manufacture.

The generative process further enables a strength optimization of the nozzle body, for example as a result of support structures in the interior and/or variable wall thicknesses.

Nozzle openings may, for example, be interrupted in part, for example with slit-shaped nozzle openings, in order to achieve a higher strength in the region of the nozzle opening.

Attachment points for the anchoring of the nozzle body can be produced by means of the generative process such that advantageously no collection points for contamination are created. For example, anchoring inserts like threaded inserts are integrated.

As a result of the generative process, different geometries of the at least one nozzle opening can be produced in a simple manner, for example obliquely extending slit-shaped nozzle openings and/or angled nozzle openings for acting on the component at an angle. In the case of an at least approximately rotationally symmetrical component, for example, a nozzle element with a screw-shaped contour similar to a helix is used, the nozzle opening then being able to extend helically around the component.

The generative manufacturing of the nozzle body further makes it possible to make the cleaning apparatus able to be used versatilely. Due to the possibility of exchanging the nozzle element, a multitude of different components can be cleaned with relatively little expenditure in production. It is possible, in particular, to aid in the generative manufacturing of the nozzle body by means of simulation methods. Here, automated optimization algorithms may be used.

In a preferred embodiment, at least one nozzle element may be of lance-shaped configuration and be insertable into cavities of the component by means of the drive device. In this way, an internal cleaning of the components can be performed. The nozzle element is advantageously adapted to contours of the cavities.

It may be advantageous if the cleaning apparatus comprises a transport device with which the component is feedable to the at least one nozzle device. In particular, a plurality of functionally equivalent or identical nozzle devices may be provided, a plurality of components being simultaneously feedable with the transport device to the nozzle devices and cleanable by same. In this way, the cycle time for cleaning components can be reduced.

The loading of the receiving device may take place, e.g., manually or by machine, for example by a robot.

Provision may be made that a monitoring device is present in order to determine whether the nozzle device intended for use is suitable for cleaning the component. It can be monitored, for example, whether at least one nozzle element is provided that is adapted to the contour of the component. Said nozzle element can preferably be selected, for example with the aforementioned adjusting device. The monitoring preferably takes place contactlessly, for example by means of an RFID technology.

The cleaning result can favorably be monitored by means of a monitoring device, for example optically, by a before/after comparison of the uncleaned component with the cleaned component.

As already mentioned, it is possible to set cleaning parameters in dependence on the component to be cleaned. Here, for example, a marking on the component or on the receiving unit can be read, for example optically by means of the aforementioned detection unit.

Before or after the cleaning of the component or in parallel thereto, provision may be made that the receiving device can be cleaned. For example, a suction, open or closed, is conceivable, for example by means of a hood, and/or an application of pressure, for example by means of movable nozzle elements.

The cleaning apparatus may have a sound insulation device, which is configured, e.g., in the form of a chamber and may be formed in the shape of a hood. Multi-layer sound insulation by, for example, hoods arranged one on top of the other is conceivable.

In a preferred embodiment of the cleaning apparatus, a cleaning operation that comprises at least two of the following steps can advantageously be performed on the components:
cleaning cavities, for example index and threaded blind bores, of the component by means of at least one lance-shaped nozzle-element;
vibrating the respective component, preferably while simultaneously acting upon same by means of the cleaning medium, for example compressed air, by way of the nozzle device while a relative movement of the component and the nozzle device advantageously takes place;
acting upon the receiving device, in particular at receiving locations for the component. This may also be performed, for example, after the cleaning of the component;
cleaning upper surfaces of the component, wherein indications of position and orientation like, for example, “top” or “bottom” are to be interpreted in relation to an intended use of the cleaning apparatus;
cleaning side surfaces of the component, preferably under relative movement to the at least one nozzle element.

Removed particles can advantageously be separated in a gravity-assisted manner. Particles removed by the cleaning medium and/or vibration can, for example, fall to the bottom and be collected in a separating device or in a collection container.

The nozzle elements may take different forms, for example with a slit-shaped nozzle opening, point jet nozzle opening, configured as a lance, as a single-component nozzle or multi-component nozzle etc. In particular, combinations of two or more of the same or different kinds of the aforementioned nozzle openings are possible, for example slit-shaped openings interrupted by webs or walls (multiple slits).

The cleaning by means of the cleaning medium may be combined with further cleaning processes, for example CO₂ cleaning, plasma cleaning, wet cleaning (e.g., with steam), and/or targeted suctioning of the component.

The action with the cleaning medium may be continuous or interrupted, for example pulsed.

Removed particles can be discharged, for example, by means of the cleaning medium itself. Alternatively, a separate carrier medium may be used, which discharges particles, for example, by means of overpressure or underpressure.

A possible cleaning chamber for accommodating the component may advantageously be cleaned in an automated manner, for example mechanically with a brush or a scraper. Alternatively or in addition, an action with a cleaning liquid may be provided. For this purpose, the cleaning apparatus may comprise, e.g., a separate nozzle device.

In a preferred embodiment, the cleaning medium may be ionized in order to reduce electrostatic charges by way of which the particles adhere to a surface of the workpiece. Correspondingly, an ionization device may be provided in order to achieve a charge equalization on the surface, for example by means of electrodes.

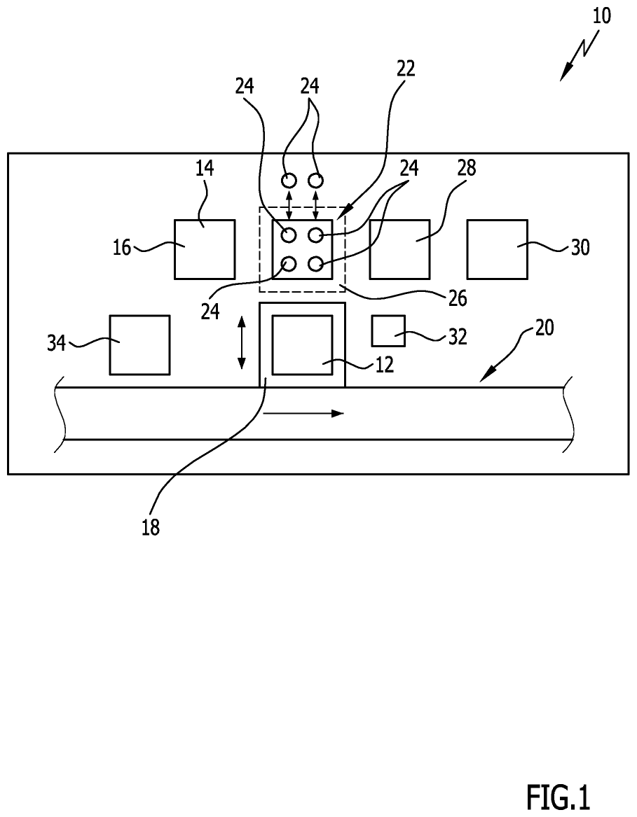

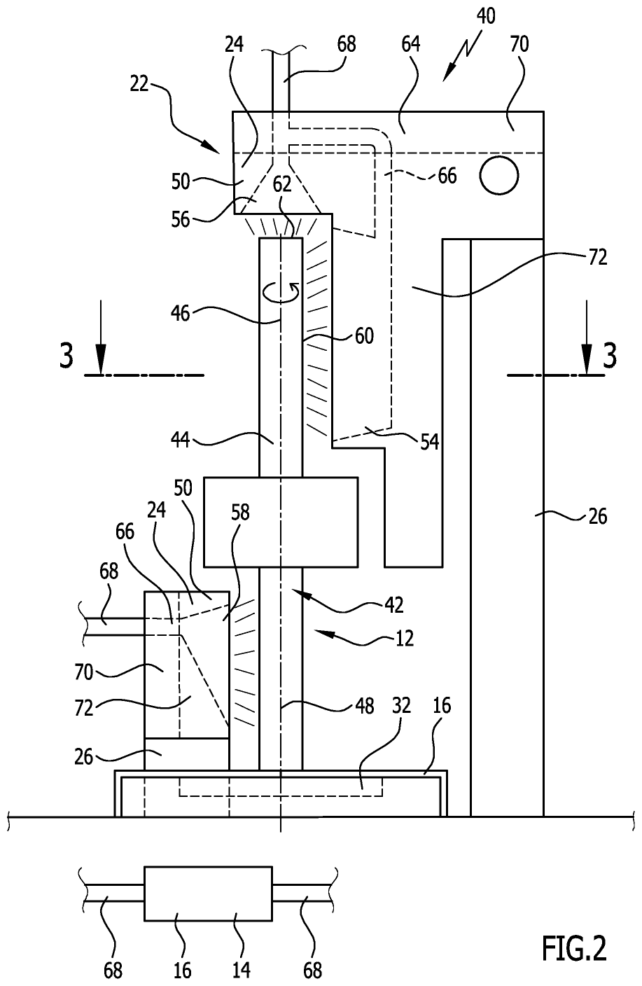

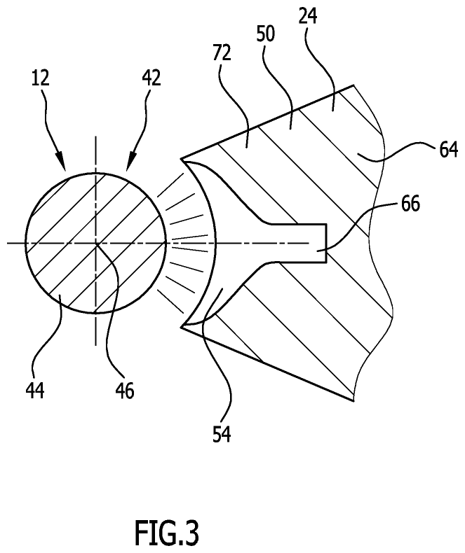

FIG. 1 shows in a schematic depiction an advantageous embodiment of a cleaning apparatus in accordance with the invention, denoted with the reference numeral 10. The cleaning apparatus 10 is configured to clean components 12 with a gaseous cleaning medium, in particular pressurized air. The components 12 are, for example, electrical components for electric motors like coil bodies, housings, bearings, or shafts. In particular, the cleaning apparatus 10 is suited for components with a rotational symmetry, as is explained in the following with reference to FIGS. 2 to 5.

For providing the pressurized air, the cleaning apparatus 10 may have a pressurization device 14, presently a pump assembly 16 for pressurized air.

The components 12 are fixed to receiving devices 18 on which they, for example, can remain during the cleaning operation and for transport.

In the present case, the cleaning apparatus 10 comprises a transport device 20. By means of the transport device 20, the receiving device 18 can be fed, with the component 12 fixed thereto, to a nozzle device 22 of the cleaning apparatus 10. The nozzle device 22 is directly or indirectly in flow connection with the pump assembly 16, such that the nozzle device 22 and, in particular, at least one nozzle element 24 of the nozzle device 22 can be acted upon with pressurized air.

The nozzle device 22 and, in particular, the nozzle elements 24 thereof are held on a holding device 26. As already explained, the cleaning apparatus 10 in accordance with the invention has the advantage that at least one nozzle element 24 on the holding device 26 is exchangeable and can be swapped for a different kind of nozzle element 24. This takes place, in particular, with a view of an optimum cleaning result, wherein a nozzle element 24 may be used that is adapted in its design to at least one contour of the component 12.

It is conceivable that at least one nozzle element 24 is releasably fixable to the holding device 26. For the purpose of said fixation, for example, a force-locking and/or positive-locking connection may be provided, in particular a screw connection, latching connection, and/or clamping connection. It is advantageous if corresponding alignment element on the nozzle element 24 and on the holding device 26 ensure a clear alignment.

In the present case, the cleaning apparatus 10 advantageously comprises an adjusting device 28, however. The adjusting device 28 is in operative connection with the nozzle device 22 such that at least one nozzle element 24 can be exchanged by the adjusting device 28 for a different kind of nozzle element 24.

The cleaning apparatus 10 may comprise a control device 30. By means of the control device, advantageously all operations of the cleaning apparatus 10 can be controlled, in particular the transport device 20, the pump assembly 16, the nozzle device 22, and the adjusting device 28.

The cleaning apparatus 10 further comprises a drive device 32. The drive device 32 serves to enable a relative movement of the component 12 and at least one nozzle element 24 during the cleaning of the component 12. The relative movement may be, in particular, a rotation about at least one axis and/or a translation in at least one spatial direction. The translation may be rectilinear. In the present case, for example, a respective drive device 32 is associated both with the component 12 and with the nozzle device 22 for moving the nozzle elements 24.

Further, the cleaning apparatus 10 may comprise a detection device 34. The component 12 can be detected by means of the detection device 34. Alternatively or in addition, it is conceivable that a marking associated with the component 12, for example on the receiving device 18, is detected. The detection device 34 is, for example, of optical configuration.

In dependence on the result of the detection, it is possible, in particular, to adapt the cleaning operation to the component 12 such that an optimal cleaning result can be achieved. This includes, in particular, controlling the pump assembly 16, the nozzle device 22, the adjusting device 28, and the drive device 32.

Provision may be made that a plurality of similarly or favorably identically configured nozzle devices 22 are provided. For example, a plurality of receiving units 18 with components 12 arranged thereon can be simultaneously transported with the transport device 20 and fed to the nozzle devices 22. The cycle time can be shortened in this way. The number of feedable receiving devices 18 favorably corresponds to the number of nozzle devices 22.

Further advantageous embodiments of the cleaning apparatus in accordance with the invention will be described in the following. Identical reference numerals are used for like or functionally equivalent features and components. The advantages that can be achieved with the cleaning apparatus 10 can also be achieved with the cleaning apparatuses mentioned below, such that reference may be made to the preceding remarks in this regard in order to avoid repetition.

FIG. 2 shows in a schematic depiction an advantageous embodiment, denoted with the reference numeral 40, of a cleaning apparatus in accordance with the invention in a partial depiction. In this example, a rotor of an electric motor is provided as a component 12. The rotor 42 comprises a shaft 44, which defines an axis 46.

A rotation device is presently provided as a drive device 32. The rotor 42 can be rotated about an axis of rotation 48 with the rotation device. Here, the axis of rotation 48 coincides with the axis 46.

The nozzle device 22 presently comprises a nozzle element 50 and a further nozzle element 52. In the present case, the nozzle elements 50, 52 are stationarily arranged on the holding device 26 and are fixed thereto by force-locking and/or positive-locking connection. As described above, it is also possible to exchange the nozzle elements 50 and 52 in order to use a nozzle element that is better adapted for the cleaning purpose and to the component 12, depending on the component 12 to be cleaned.

The nozzle elements 50, 52 are adapted to the rotor 42. Here, it is possible to act upon the rotor 42 radially and axially, in relation to the axis 46, with pressurized air by means of the nozzle element 50. A first nozzle opening 54 makes it possible to act with pressurized air in the radial direction and a second nozzle opening 56 makes it possible to act with the pressurized air in the axial direction.

In the case of the nozzle element 52, it is possible to act upon the rotor 42 by way of a nozzle opening 58 in the radial direction.

The nozzle device 22 is thus configured such that a plurality of surfaces of the rotor 42 can be cleaned simultaneously, in particular a side surface or an outer surface 60 and an end face 62.

The nozzle elements 24 of the nozzle device 22 and thus, for example, the nozzle elements 50 and 52 are advantageously produced by means of a generative process. For example, the nozzle elements 50, 52 are produced at least partially by means of 3D printing.

The nozzle elements 24, 50, 52 comprise, e.g., a nozzle body 64, which is formed in one piece and in which a flow channel 66 is formed. The flow channel 66 is in flow connection with the pump assembly 16 by way of a supply conduit 68, for example a hose conduit.

The nozzle body 64 comprises a supply portion 70 to which the supply conduit 68 is connected, and a dispensing portion 72 on which the nozzle opening 54, 56, 58 is formed. The flow channel 66 extends from the supply portion 70 to the dispensing portion 72.

Favorably at least the dispensing portion 72 is formed in one piece with the nozzle opening 54, 56, 58, specifically by 3D printing. This makes it possible to adapt the nozzle openings 54, 56, 58 as best as possible with a view to the cleaning task to be fulfilled. Here, an adaptation, in particular, to at least one contour of the component 12 can be performed.

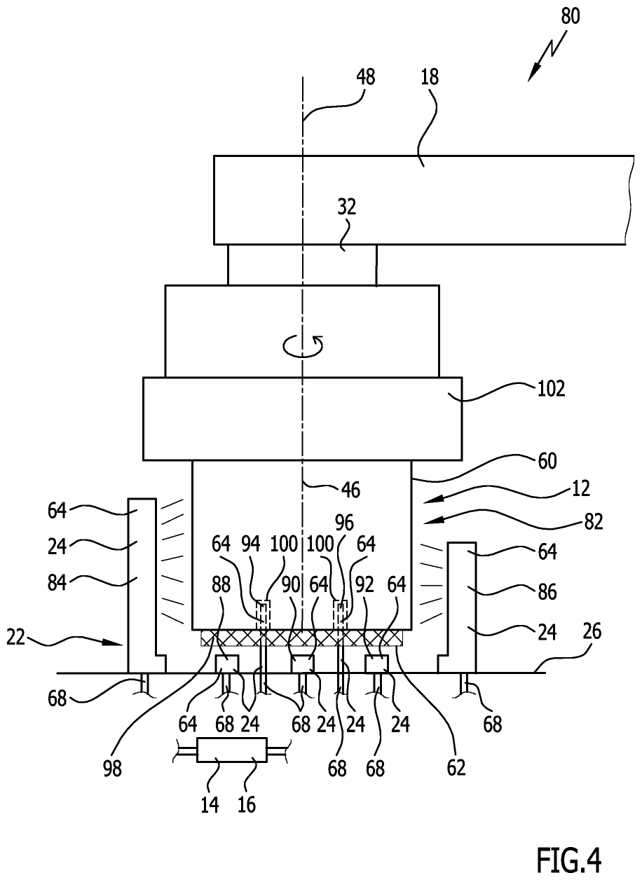

FIG. 4 shows schematically an advantageous embodiment, denoted as a whole with the reference numeral 80, of the cleaning apparatus in accordance with the invention in a partial depiction.

In this example, a stator 82 of an electric motor is used as a component 12. The stator 82, like the rotor 42, has substantially a rotational symmetry. The stator 82 is held on the receiving device 18, the latter presently being, for example, a robotic arm. The stator 82 can be rotated about the axis of rotation 48 by means of the drive device 32. The axis of rotation 48 coincides with an axis 46 of the stator 82.

The nozzle device 22 presently comprises as a nozzle element 24 a plurality of nozzle elements that are designated with the reference numerals 84, 86, 88, 90, 92, 94, and 96. In the present case, the nozzle bodies 64 of the nozzle elements 84 to 96 are also advantageously generatively manufactured, in particular by means of 3D printing. Reference is made to the preceding statements regarding the advantages of such a manufacturing method.

The nozzle elements 84, 86 are adapted to the shell-like side surface 60 of the stator 82. In particular, it is possible to act upon the side surface 60 with pressurized air in the radial direction.

The nozzle elements 80, 90, and 92 are adapted to clean an end face 62 of the stator 82. Here, in particular, coils 98 of the stator 82 that form the end face 62 can be cleaned.

In the present case, the nozzle elements 94, 96 are of lance-shaped configuration. This makes it possible to penetrate into cavities 100 of the stator 82. For example, the receiving device 18 is lowered and raised so that the lances are inserted into the cavities 100. Alternatively, the raising or lowering may be effected by means of the drive device 32. The nozzle elements 94, 96 are also adapted to the contours of the stator 82, in the present case to contours of the cavities 100.

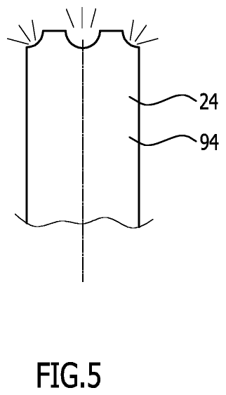

FIG. 5 shows as an example the nozzle element 94 with a plurality of nozzle openings in an enlarged depiction.

In the present case, the nozzle elements 84 to 96 are releasably fixed to the holding device 26, for example by force-locking and/or positive-locking connection, in particular by a screw connection, latching connection, and/or clamping connection. A simple and quick change of at least one of the nozzle elements 84 to 96 is possible.

Not all advantageously present components of the cleaning apparatus are depicted in connection with the cleaning apparatuses 40 and 80. It is understood, however, that, for example like in the case of the cleaning apparatus 10, the transport device 20, the adjusting device 28, the control device 30, and/or the detection device 34 may be present.

The cleaning apparatus 80 comprises a vibration device 102, which may preferably also be present in the cleaning apparatuses 10 and 40. The vibration device 102, which is preferably controllable by the control device 30, is presently indirectly or directly fixed to the component 12, for example to the receiving device 18. The component 12 can be set into vibration by way of the vibration device 102. Adhering particles are thereby detached from the component 12 and are preferably struck by the cleaning medium acting upon the component 12 and are discharged.

### REFERENCE NUMERAL LIST

10, 40, 80 cleaning apparatus

12 component

14 pressurization device

16 pump assembly

18 receiving device

20 transport device

22 nozzle device

24 nozzle element

26 holding device

28 adjusting device

30 control device

32 drive device

34 detection device

36 rotor

44 shaft

46 axis

48 axis of rotation

50, 52 nozzle element

54, 56, 58 nozzle opening

60 side surface

62 end face

64 nozzle body

66 flow channel

68 supply conduit

70 supply portion

72 dispensing portion

82 stator

84, 86, 88, 90, 92, 94, 96 nozzle element

98 coil

100 cavity

102 vibration device

1. Cleaning apparatus for cleaning components with a gaseous cleaning medium,
comprising a receiving device to which the component is fixed or fixable, a nozzle device with at least one nozzle element directed or directable at the component and a holding device for said nozzle, wherein at least one nozzle element is adapted to at least one contour of the component,
as well as a pressurization device for acting upon the nozzle device with the cleaning medium,
wherein at least one nozzle element of the nozzle device is exchangeably fixable or fixed to the holding device,
and wherein the cleaning apparatus comprises at least one drive device, which is in operative connection with at least one of the component and the nozzle device, for achieving a relative movement of the component and the at least one nozzle element during the cleaning.

2. Cleaning apparatus in accordance with claim 1, wherein at least one of:
at least one nozzle element is adapted to an outer contour or an envelope surface of the component; and
at least one nozzle element of the nozzle device is releasably fixable or fixed to the holding device.

3. Cleaning apparatus in accordance with claim 1, wherein the at least one drive device is configured to achieve at least one of a relative rotation of the component and the at least one nozzle element and a translational movement of the component and the at least one nozzle element relative to one another.

4. Cleaning apparatus in accordance with claim 1, wherein the cleaning apparatus comprises a conditioning device for setting at least one of the temperature and the humidity of the cleaning medium.

5. Cleaning apparatus in accordance with claim 1, wherein an intensity of the cleaning is settable and at least one of the following is provided:
setting the pressure of the cleaning medium;
setting the process time of the action on the component by means of at least one nozzle element or of a plurality of nozzle elements;
setting a speed of the relative movement of the component and at least one nozzle element, rotationally and/or translationally;
setting or changing a direction of the relative rotation and/or a movement direction of the component and at least one nozzle element, for example providing a repeated reversal of the direction of rotation;
selecting and setting the cleaning medium;
setting the cross section of at least one nozzle opening of at least one nozzle element.

6. Cleaning apparatus in accordance with claim 1, wherein the cleaning apparatus comprises or forms a cleaning chamber.

7. Cleaning apparatus in accordance with claim 1, wherein the component is adapted to be acted upon by means of an electrical application device.

8. Cleaning apparatus in accordance with claim 1, wherein the at least one nozzle element is stationarily fixed to the holding device and wherein the component is rotated or displaced relative to the nozzle element by means of the drive device, or wherein the component is stationarily fixed to the receiving device and wherein the at least one nozzle element is rotated or displaced relative to the component by means of the drive device.

9. Cleaning apparatus in accordance with claim 1, wherein the at least one nozzle element is fixed to the holding device by at least one of a force-locking and positive-locking connection, by a screw connection, at least one of a latching connection and a clamping connection.

10. Cleaning apparatus in accordance with claim 1, wherein the cleaning apparatus comprises a controllable adjusting device, by means of which the at least one nozzle element is exchangeably held on the holding device.

11. Cleaning apparatus in accordance with claim 1, wherein the cleaning apparatus comprises a detection unit with which the component is detectable, wherein at least one of at least one cleaning operation and at least one cleaning parameter is settable in dependence on the component.

12. Cleaning apparatus in accordance with claim 1, wherein the nozzle device comprises a set of nozzle elements that are mutually exchangeable.

13. Cleaning apparatus in accordance with claim 12, further comprising an adjusting device for exchanging the nozzle elements.

14. Cleaning apparatus in accordance with claim 1, wherein the at least one nozzle element is adapted to rotationally symmetrically configured components or components that are of cylindrical configuration at least in sections.

15. Cleaning apparatus in accordance with claim 14, wherein a nozzle opening of the at least one nozzle element is adapted to rotationally symmetrically configured components or components that are of cylindrical configuration at least in sections.

16. Cleaning apparatus in accordance with claim 1, wherein at least one nozzle element comprises a plurality of nozzle openings, by way of which different portions of the component are cleanable depending on the orientation relative to the component.

17. Cleaning apparatus in accordance with claim 1, wherein the component is adapted to be acted upon at least one of axially, radially and tangentially with cleaning medium by means of the at least one nozzle element, in relation to an axis defined by the component.

18. Cleaning apparatus in accordance with claim 1, wherein at least one nozzle element of the nozzle device comprises a nozzle body with a supply portion and a dispensing portion having at least one nozzle opening, wherein the nozzle body is formed at least partially in one piece and a flow channel for the cleaning medium is integrally formed in at least one of the supply portion and the dispensing portion.

19. Cleaning apparatus in accordance with claim 18, wherein the nozzle body is produced at least in sections by means of a generative process.

20. Cleaning apparatus in accordance with claim 19, wherein at least one of:
the nozzle body is produced by means of 3D printing; and
the nozzle body is produced by means of a generative process at the dispensing portion.

21. Cleaning apparatus in accordance with claim 1, wherein at least one nozzle element is of lance-shaped configuration and is insertable by means of the drive device into cavities of the component.

22. Cleaning apparatus in accordance with claim 21, wherein the nozzle element is adapted to contours of the cavities.

23. Cleaning apparatus in accordance with claim 1, wherein the cleaning apparatus comprises a transport device with which the component is feedable to the at least one nozzle device and wherein a plurality of components are simultaneously feedable to the nozzle devices by the transport device and are cleanable by said nozzle devices.

24. Cleaning apparatus in accordance with claim 23, wherein a plurality of functionally equivalent or identical nozzle devices are provided.

25. Cleaning apparatus in accordance with claim 1, wherein the cleaning apparatus comprises a monitoring device for determining whether the nozzle device intended for use is suitable for cleaning the component.

26. Cleaning apparatus in accordance with claim 1, wherein a performance of a cleaning operation on the components is provided, comprising at least two of the following steps:
cleaning cavities of a respective component by means of at least one lance-shaped nozzle element;
vibrating the respective component, while a relative movement of the component and the nozzle device takes place;
acting upon the receiving device;
cleaning upper surfaces of the component;
cleaning side surfaces of the component.

27. Cleaning apparatus in accordance with claim 26, wherein at least one of:
vibrating the respective component is performed while simultaneously acting upon same by means of the cleaning medium by way of the nozzle device; and
acting upon the receiving device comprises acting upon receiving locations for the component.

28. Cleaning apparatus in accordance with claim 1, wherein the cleaning apparatus comprises a vibration device for acting upon the component with vibrations.

29. Method for cleaning components with a gaseous cleaning medium, in which at least one nozzle element of a nozzle device adapted to at least one contour of the component is selected in dependence on the component and is directed at the component and the component is acted upon with the cleaning medium, wherein the component and the at least one nozzle element are moved relative to one another during the cleaning.

30. Method in accordance with claim 29, wherein at least one of:
at least one nozzle element of a nozzle device is adapted to an outer contour or an envelope surface of the component; and
the selection of the nozzle element comprises the exchange of the at least one nozzle element on a holding device.
